(19) United States
(12) Patent Application Publication
(10) Pub. No.: US 2025/0286443 A1
(43) Pub. Date: Sep. 11, 2025

(54) MOTOR

(71) Applicant: LG INNOTEK CO., LTD., Seoul (KR)

(72) Inventor: Sung Joo OH, Seoul (KR)

(73) Assignee: LG INNOTEK CO., LTD., Seoul (KR)

(21) Appl. No.: 18/859,297

(22) PCT Filed: Apr. 25, 2023
(86) PCT No.: PCT/KR2023/005616

§ 371 Date: Oct. 23, 2024

(30) Foreign Application Priority Data
May 18, 2022 (KR) 10-2022-0060539

(51) Int. Cl. H02K 11/215; H02K 7/08; H02K 21/16

(52) U.S. Cl. CPC H02K 11/215; H02K 7/085; H02K 21/16

(57) ABSTRACT

A motor comprises: a housing; a stator disposed inside the housing; a rotor disposed inside the stator; a shaft coupled to the center of the rotor; and a sensor magnet disposed outside the shaft, wherein a groove, in which the sensor magnet is disposed, is formed on one surface of the rotor.

### TECHNICAL FIELD

The present embodiment relates to a motor.

### BACKGROUND ART

A motor is a device that converts an electrical energy into a rotational energy by using the force a conductor receives in a magnetic field. Recently, as the uses of motors have expanded, the role of motors has become more important. In particular, as the electrification of automobiles progresses rapidly, the demand for motors being applied to steering systems, braking systems, and design systems is increasing significantly.

The motor includes a housing, a stator being disposed inside the housing, and a rotor being disposed inside the stator, and is a device that generates rotational motion by electromagnetic interaction between the stator and the rotor. Specifically, a coil is wound on the stator, and a magnet facing the coil is disposed on the rotor, so that the rotor can rotate by the action of the coil and magnet.

In addition, the motor includes a sensor magnet and a sensor to detect the rotational position of the rotor or rotation shaft. For example, a sensor magnet is disposed on one surface of the rotor, and a sensor is disposed in a housing facing the sensor magnet, and the sensor detects the magnetic field of the sensor magnet to detect the position of the rotor or shaft.

However, according to the prior art, there is a problem that the overall size of the motor increases due to the structure in which the rotor, sensor magnet, and sensor are disposed in an axial direction.

### DETAILED DESCRIPTION OF THE INVENTION

### Technical Subject

The present embodiment is intended to provide a motor that can be miniaturized by improving its structure.

### Technical Solution

A motor according to the present embodiment comprises: a housing; a stator being disposed inside the housing; a rotor being disposed inside the stator; a shaft being coupled to the center of the rotor; and a sensor magnet being disposed outside the shaft, wherein a groove in which the sensor magnet is disposed is formed on one surface of the rotor.

It may include a bearing being disposed to face one surface of the rotor and supporting the rotation of the shaft.

The rotor includes a rotor core and a magnet being disposed on an outer surface of the rotor core, wherein the groove may be formed on one surface of the rotor core facing the bearing.

With respect to an axial direction, the length between the sensor magnet and the bearing may be longer than the length between the rotor core and the bearing.

With respect to a radial direction, at least a portion of the rotor core may be disposed to be overlapped with the sensor magnet.

With respect to an axial direction, the length of the groove may be ½ or less than the length of the rotor core.

The sensor magnet includes one surface facing the bearing and the other surface facing the one surface, wherein the other surface of the magnet may be in contact with the bottom surface of the groove.

It includes a sensor plate in which the shaft is coupled to the center thereof and the sensor magnet is disposed on one surface facing the bearing, wherein the sensor plate may be disposed inside the groove.

The sensor plate includes: a first region being disposed outside the shaft; and a second region being extended outward in a radial direction from one end of the first region and perpendicular to the first region, wherein the sensor magnet may be disposed on a surface of the second region.

The surface of the second region facing the bearing and the surface of the sensor magnet may form the same plane.

### Advantageous Effects

Through the present embodiment, since the length in an axial direction of a motor can be reduced by forming an arrangement region of a sensor magnet through a groove of a rotor core, there is an advantage that enables miniaturization of a motor.

In addition, since the length of a shaft is also reduced compared to the prior art and volume reduction is accomplished due to the forming of a groove, there are advantages that material cost is reduced and weight reduction is accomplished compared to the prior art.

In addition, since it is a structure in which a sensor plate is supported by being in contact with the bottom surface of a groove, there is an advantage of improved assemblability.

### BRIEF DESCRIPTION OF DRAWINGS

FIG. 1 is a perspective view illustrating an outer appearance of a motor according to an embodiment of the present invention.

FIG. 2 is a cross-sectional view of a motor according to an embodiment of the present invention.

FIG. 3 is an exploded perspective view of a motor according to an embodiment of the present invention.

FIG. 4 is a perspective view of a rotor according to an embodiment of the present invention.

FIG. 5 is an exploded perspective view of a rotor according to an embodiment of the present invention.

FIG. 6 is a cross-sectional view of a rotor according to an embodiment of the present invention.

FIGS. 7 to 9 are diagrams illustrating a modified embodiment of a rotor and a sensor magnet according to an embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention. In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used.

These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or disposed in “on (above)” or “below (under)” of each component, “on (above)” or “below (under)” means that it includes not only the case where the two components are directly in contact with, but also the case where one or more other components are formed or disposed between the two components. In addition, when expressed as “on (above)” or “below (under)”, the meaning of not only an upward direction but also a downward direction based on one component may be included.

The ‘axial direction’ used hereinafter may be a lengthwise direction of the shaft.

The ‘radial direction’ used hereinafter may be a direction perpendicular to the ‘axial direction’.

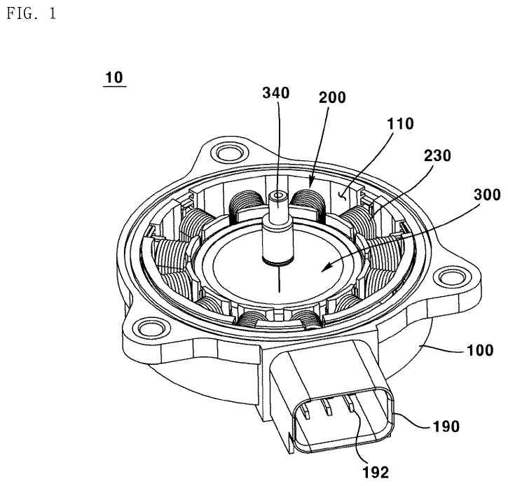

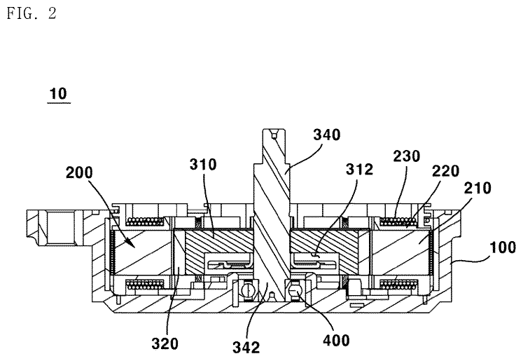

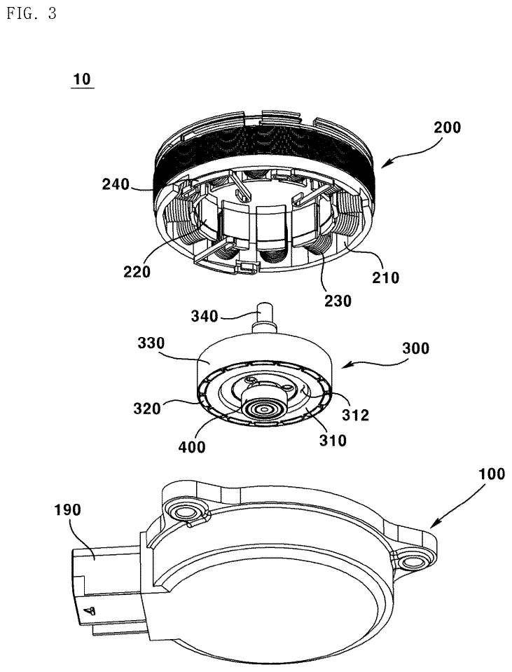

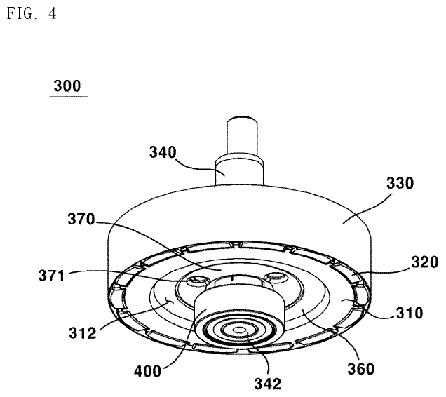

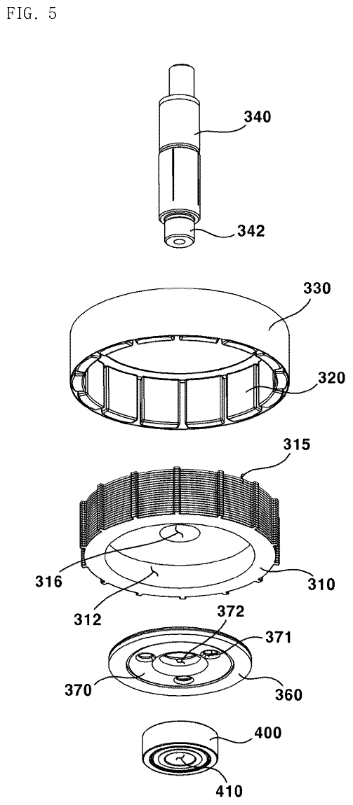

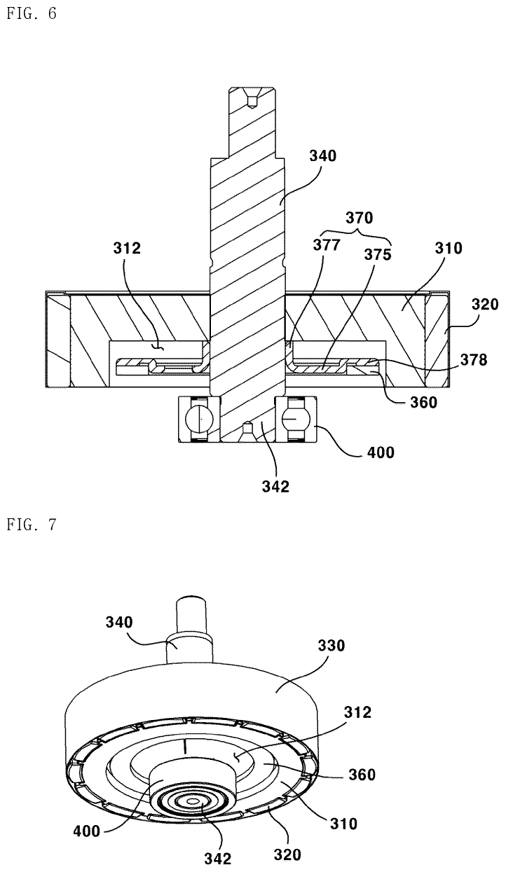

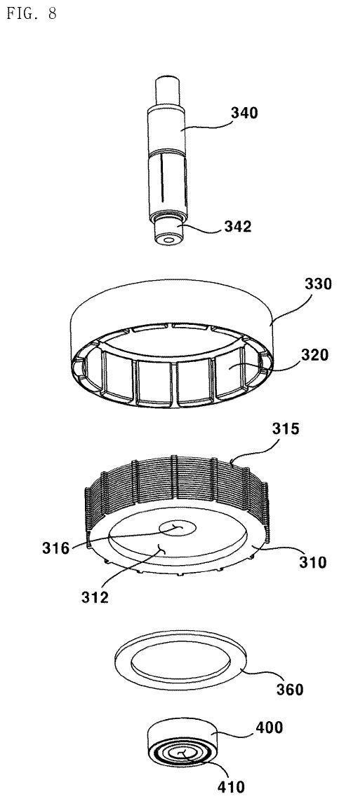

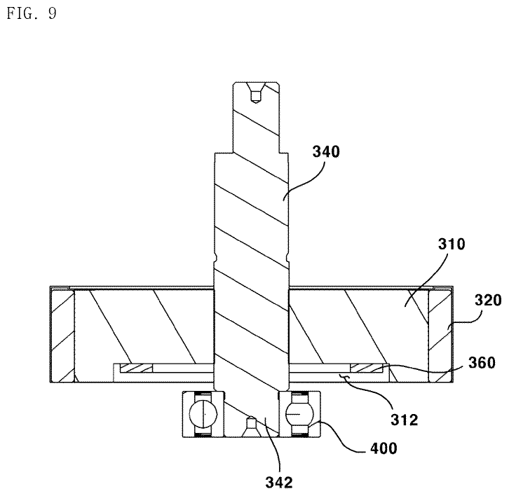

FIG. 1 is a perspective view illustrating an outer appearance of a motor according to an embodiment of the present invention; FIG. 2 is a cross-sectional view of a motor according to an embodiment of the present invention; FIG. 3 is an exploded perspective view of a motor according to an embodiment of the present invention; FIG. 4 is a perspective view of a rotor according to an embodiment of the present invention; FIG. 5 is an exploded perspective view of a rotor according to an embodiment of the present invention; FIG. 6 is a cross-sectional view of a rotor according to an embodiment of the present invention; and FIGS. 7 to 9 are diagrams illustrating a modified embodiment of a rotor and a sensor magnet according to an embodiment of the present invention.

Referring to FIGS. 1 to 6, the motor 10 according to an embodiment of the present invention may comprise a housing 100, a stator 200, a rotor 300, a shaft 340, and a bearing 400.

The housing 100 may form an outer shape of the motor 10. The housing 100 may have a cylindrical shape with an open upper surface. A space 110 for accommodating the stator 200, the rotor 300, and the shaft 340 may be formed inside the housing 100. An upper surface of the space 110 may be opened upward. A cover (not shown) may be coupled to an upper surface of the housing 100. The space 110 may be closed by the coupling of the cover.

The connector terminal 190 may be formed on a side surface of the housing 100. The connector terminal 190 may have a shape being protruded outward from the other region of an outer surface of the housing 100. A space to which an external terminal (not shown) is coupled may be formed inside the connector terminal 190. A pin 192 being electrically connected to the external terminal may be disposed inside the connector terminal 190. Power may be provided to the motor 10 by electrical connection between the external terminal and the pin 192, or an electric signal related to driving of the motor 10 may be transmitted or received.

The stator 200 may be disposed inside the housing 10. The stator 200 may include a stator core 210, an insulator 220, and a coil 230.

The stator core 210 may include a circular body and a plurality of teeth being protruded inward from an inner surface of the body. The plurality of teeth may be disposed to be spaced apart from one another along a circumferential direction.

The insulator 220 may be coupled to an outer surface of the stator core 210. The insulator 220 may be disposed to surround an outer surface of the stator core 210.

The coil 230 may be wound around an outer surface of the insulator 220.

A bus bar 240 may be disposed on one surface of the stator core 210. The coil 230 may be coupled to the bus bar 240. A plurality of bus bars 240 may be provided to correspond to the polarity of the coil 230 and may be disposed to be spaced apart from one another along a circumferential direction.

The rotor 300 may be disposed inside the stator 200. The rotor 300 may include a rotor core 310, a magnet 320, and a cover plate 330.

The rotor core 310 may have a circular cross-sectional shape. A hole 316 to which the shaft 340 is coupled may be formed in the center of the rotor core 310. A magnet coupling part 315, to which the magnet 320 is coupled, may be formed on an outer surface of the rotor core 310. The magnet coupling part 315 may have a groove shape being recessed inwardly than other regions. A plurality of magnet coupling parts 315 may be provided and may be disposed to be spaced apart from one another along a circumferential direction. Accordingly, a region between two magnet coupling parts 315 being disposed adjacent to each other may have a shape being protruded outward.

The magnet 320 may be coupled to an outer surface of the rotor core 310. The magnet 320 may be disposed to face the coil 230. The magnet 320 may be mounted on an outer circumferential surface of the rotor core 310. The magnet 320 may be coupled to the magnet coupling part 315. The magnet 320 may be coupled to the rotor core 310 by an adhesive. In this case, the adhesive may be disposed between an inner surface of the magnet 320 and a bottom surface of the magnet coupling part 315. A plurality of magnets 320 may be provided and disposed to be spaced apart from one another along a circumferential direction of the rotor core 310. An outer surface of the magnet 320 may be protruded outward from an outer surface of the rotor core 310 with respect to a radial direction.

The cover plate 330 may be disposed outside the rotor core 310. The cover plate 330 may have a ring-shaped cross-sectional shape. The cover plate 330 may be disposed to cover the outer surface of the magnet 320 and the outer surface of the rotor core 310. An adhesive may be disposed between the inner surface of the cover plate 330 and the outer surface of the magnet 320, and between the inner surface of the cover plate 330 and the outer surface of the rotor core 310.

With respect to an axial direction, the length of the cover plate 330 may correspond to the length of the magnet 320 or the length of the rotor core 310.

The shaft 340 may be coupled to the center of the rotor 300. The shaft 340 may be disposed to penetrate the hole 316 formed at the center of the rotor core 310. Therefore, the shaft 340 may rotate together with the rotor 300 by the electromagnetic interaction between the magnet 320 and the coil 230.

The rotor 300 may include a plurality of regions having different cross-sectional areas. For example, a bearing coupling part 342 being formed to have a cross-sectional area smaller than that of the other region may be disposed at one end of the rotor 300.

A bearing 400 may be disposed in a region being spaced apart from the rotor 300 by a predetermined distance in an axial direction. The bearing 400 may support rotation of the rotor 300 and the shaft 340. The bearing 400 may be disposed in a space inside the housing 100. The bearing 400 may be a ball bearing having a ball being disposed between an inner wheel and an outer wheel. A hole 410 to which the shaft 340 is coupled may be formed at the center of the bearing 400. A bearing coupling part 342 of the shaft 340 may be coupled to the hole 410. Accordingly, the rotation of the shaft 340 may be supported through the bearing 400.

The bearing 400 and the rotor 300 may be disposed to be spaced apart from each other by a predetermined distance along an axial direction. For example, an interval between the bearing 400 and the rotor core 310 may be 1 mm or more and 3 mm or less with respect to the axial direction.

Meanwhile, in order to detect the positions of the rotor 300 and the shaft 340, the motor 10 may include a sensor magnet 360 and a sensor (not shown).

In detail, a groove 312 being formed to be recessed more than the other region may be formed on one surface of the rotor core 310 facing the bearing 400. When the groove 312 is formed on a lower surface of the rotor core 310, the bottom surface of the groove 312 may be disposed to be stepped upward than a lower surface of the rotor core 310. The groove 312 may have a circular cross-sectional shape. The cross-sectional area of the groove 312 may be formed to be smaller than the cross-sectional area of the rotor core 310. The length of the groove 312 may be equal to or less than ½ of the length of the rotor core 310 with respect to an axial direction.

The sensor magnet 360 may be disposed in the groove 312.

The sensor magnet 360 may be coupled to the shaft 340 and the rotor core 320 through a sensor plate 370. The sensor plate 370 may include a first region 377 being disposed to surround an outer surface of the shaft 340, and a second region 375 being bent radially outward and extended from one end of the first region 377. The first region 377 and the second region 375 may be disposed to be perpendicular to each other.

A hole 372 through which the shaft 340 penetrates may be formed at the center of the first region 377. The shaft 340 may be press-fitted into the hole 372, and accordingly, the shaft 340 may be disposed to penetrate the sensor plate 370. One end of the first region 377 may be in contact with a bottom surface of the groove 312.

The second region 375 may be formed to be extended radially outward from a lower end of the first region 377. The second region 375 may be disposed perpendicular to the shaft 340. The second region 375 may include an opening 371 penetrating from one surface to the other surface. The opening 371 may be disposed outside the hole 372. A plurality of openings 371 may be provided and may be disposed to be spaced apart from one another along a circumferential direction of the second region 375. For example, three openings 371 may be provided, and the three openings 371 may be disposed to form an equal interval of 120 degrees. In the process of assembling the motor 10, a coupling force between the sensor magnet 360 and the sensor plate 370 may be identified through the opening 371.

A sensor magnet coupling part 378 having a shape being recessed more than the other region may be formed on one surface of the second region 375 facing the bearing 400. The sensor magnet coupling part 378 may have a groove shape. The bottom surface of the sensor magnet coupling part 378 may be disposed to be stepped more upward than the bottom surface of the second region 375.

The sensor magnet 360 may be disposed on the sensor magnet coupling part 378. The sensor magnet 360 may have a cross-sectional shape of a ring shape. One surface of the sensor magnet 360 may form a coplanar surface with one surface of the second region 375. The bottom surface of the sensor magnet 360 may form a coplanar surface with the bottom surface of the second region 375. The sensor magnet 360 may be coupled to the sensor plate 370 by an adhesive. The sensor magnet 360 may be spaced apart from the bottom surface of the groove 312 by a predetermined distance.

The sensor magnet 360 may rotate with the shaft 340 together with the sensor plate 370.

A sensor (not shown) may be disposed inside the housing 100 being spaced apart from the sensor magnet 360. For example, the sensor may be disposed at a lower portion of the housing 100 being spaced apart from the sensor magnet 360 in an axial direction. The sensor may be disposed on a surface of a printed circuit board (not shown), and may detect positions of the rotor 300 and the shaft 340 by detecting a magnetic field being changed according to rotation of the sensor magnet 360.

In the motor 10 according to the present embodiment, the sensor plate 370 and the sensor magnet 360 may be disposed inside the groove 312 of the rotor core 310. Accordingly, the length between the sensor plate 370 and the bearing 400 may be formed to be longer with respect to the axial direction. The length between the sensor magnet 360 and the bearing 400 may be formed to be longer than the length between the rotor core 310 and the bearing 400. A lower surface of the sensor plate 370 or a lower surface of the sensor magnet 360 may be disposed to be stepped more upward than a lower surface of the rotor core 310. The sensor plate 370 and the sensor magnet 360 may be disposed to be overlapped with the magnet 320 in a radial direction. The sensor plate 370 and the sensor magnet 360 may be disposed to be overlapped with the rotor core 310 in a radial direction.

According to the above structure, the length of the motor 10 can be reduced with respect to an axial direction by forming an arrangement region of the sensor magnet 360 through the groove 312 of the rotor core 310, so that there is an advantage that the motor 10 can be miniaturized.

In addition, since the length of a shaft 340 is also reduced compared to the prior art and volume reduction of the rotor core 310 is accomplished due to the forming of a groove 312, there are advantages that material cost is reduced and weight reduction is accomplished compared to the prior art.

In addition, since it is a structure in which a sensor plate 370 is supported by being in contact with the bottom surface of a groove 312, there is an advantage of improved assemblability.

Meanwhile, referring to FIGS. 7 to 9, the sensor plate 370 may be omitted from the motor 10. In this case, only the sensor magnet 360 can be disposed in the groove 312 of the rotor core 310.

In the present modified embodiment, by omitting the sensor plate 370, the axial length of the groove 312 can be formed shorter than in the above-described embodiment. In addition, in the present modified embodiment, an upper surface of the sensor magnet 360 may be in contact with the bottom surface of the groove 312. In this case, the upper surface of the sensor magnet 360 may be coupled to the bottom surface of the groove 312 with an adhesive.

In the above description, it is described that all the components constituting the embodiments of the present invention are combined or operated in one, but the present invention is not necessarily limited to these embodiments. In other words, within the scope of the present invention, all of the components may be selectively operated in combination with one or more. In addition, the terms “comprise”, “include” or “having” described above mean that the corresponding component may be inherent unless specifically stated otherwise, and thus it should be construed that it does not exclude other components, but further include other components instead. All terms, including technical and scientific terms, have the same meaning as commonly understood by one of ordinary skill in the art unless otherwise defined. Terms used generally, such as terms defined in a dictionary, should be interpreted to coincide with the contextual meaning of the related art, and shall not be interpreted in an ideal or excessively formal sense unless explicitly defined in the present invention.

The above description is merely illustrative of the technical idea of the present invention, and those skilled in the art to which the present invention pertains may make various modifications and changes without departing from the essential characteristics of the present invention. Therefore, the embodiments disclosed in the present invention are not intended to limit the technical idea of the present invention but to describe the present invention, and the scope of the technical idea of the present invention is not limited by these embodiments. The protection scope of the present invention should be interpreted by the following claims, and all technical ideas within the equivalent scope should be interpreted as being included in the scope of the present invention.

1. A motor comprising:
a housing;
a stator disposed inside the housing;
a rotor disposed inside the stator;
a shaft coupled to a center of the rotor; and
a sensor magnet disposed outside the shaft,
wherein a groove in which the sensor magnet is disposed is formed on one surface of the rotor.

2. The motor according to claim 1, including:
a bearing disposed to face one surface of the rotor and supporting a rotation of the shaft.

3. The motor according to claim 2, wherein the rotor includes a rotor core and a magnet disposed on an outer surface of the rotor core,
wherein the groove is formed on one surface of the rotor core facing the bearing.

4. The motor according to claim 3, wherein with respect to an axial direction, a length between the sensor magnet and the bearing is longer than a length between the rotor core and the bearing.

5. The motor according to claim 3, wherein with respect to a radial direction, at least a portion of the rotor core is disposed to be overlapped with the sensor magnet.

6. The motor according to claim 3, wherein with respect to an axial direction, a length of the groove is ½ or less than a length of the rotor core.

7. The motor according to claim 2, wherein the sensor magnet includes one surface facing the bearing and the other surface facing the one surface, and
wherein the other surface of the magnet is in contact with a bottom surface of the groove.

8. The motor according to claim 2, including:
a sensor plate in which the shaft is coupled to a center thereof and the sensor magnet is disposed on one surface facing the bearing,
wherein the sensor plate is disposed inside the groove.

9. The motor according to claim 8, wherein the sensor plate includes a first region disposed outside the shaft, and a second region extended outward in a radial direction from one end of the first region and perpendicular to the first region,
wherein the sensor magnet is disposed on a surface of the second region.

10. The motor according to claim 9, wherein the surface of the second region facing the bearing and the surface of the sensor magnet form the same plane.

11. The motor according to claim 9, wherein an end of the first region contacts a bottom surface of the groove.

12. The motor according to claim 3, wherein with respect to an axial direction, the rotor core and the bearing are spaced apart.

13. The motor according to claim 9, wherein the second region includes a plurality of openings arranged at equal intervals along a circumferential direction.

14. The motor according to claim 1, wherein the sensor magnet is spaced apart from a bottom surface of the groove.

15. The motor according to claim 3, comprising a cover plate disposed on an outside of the rotor core,
wherein the magnet is disposed between the rotor core and the cover plate.

16. A motor comprising:
a housing;
a stator disposed inside the housing;
a rotor disposed inside the stator;
a shaft coupled to a center of the rotor;
a sensor magnet disposed outside the shaft; and
a sensor plate on which the shaft is coupled at a center and the sensor magnet is placed on one side.

17. The motor according to claim 16, wherein the rotor includes a groove in which the sensor magnet and the sensor plate are disposed.

18. The motor according to claim 17, including a bearing disposed to face one surface of the rotor and supporting a rotation of the shaft.

19. The motor according to claim 18, wherein the rotor includes a rotor core and a magnet disposed on an outer surface of the rotor core, and
wherein the groove is formed on one surface of the rotor core facing the bearing.

20. The motor according to claim 19, wherein with respect to an axial direction, a length between the sensor magnet and the bearing is longer than a length between the rotor core and the bearing.
